(19) United States
(12) Patent Application Publication
(10) Pub. No.: US 2010/0242433 A1
(43) Pub. Date: Sep. 30, 2010

(54) METHOD FOR IMPROVING THE PERFORMANCE OF A BYPASS TURBOJET ENGINE

(76) Inventors: Damien Prat, Colomiers (FR); Frank Crosta, Leguevin (FR)

Correspondence Address: J. Rodman Steele;Novak Druce & Quigg LLP, 525 Okeechobee Blvd, Suite 1500, West Palm Beach, FL, 33401, US

(21) Appl. No.: 12/741,360

(22) PCT Filed: Oct. 30, 2008
(86) PCT No.: PCT/FR2008/001529

§ 371 Date: May 4, 2010

(30) Foreign Application Priority Data
Nov. 6, 2007 (FR) 07 07783

(51) Int. Cl. F02K 3/06

(52) U.S. Cl. 60/204; 60/226.1

(57) ABSTRACT

Method for improving the performance of a bypass turbojet engine. According to the invention, the area of the annular outlet orifice (6) for the cold stream (9) is tailored to suit a reference value of the expansion ratio of said cold stream (9) which ranges between the extreme values of said expansion ratio corresponding respectively to the start and end of the phase of cruising flight.

The present invention relates to improvements to aircraft bypass turbojet engines, said improvements making it possible to enhance the performance of said turbojet engines and reduce the noise they make in cruising flight.

More specifically, the invention relates to bypass turbojet engines, for example described in document WO 2006/123035, of the type comprising, about a longitudinal axis:
a nacelle provided with a nacelle outer cowl and containing a fan generating the cold flow and a central generator generating the hot flow;
an annular cold flow duct formed around said central hot flow generator;
a fan outer cowl delimiting said annular cold flow duct on the nacelle outer cowl side;
an annular cold flow outlet orifice of which the edge, which forms the trailing edge of said nacelle, is determined by said nacelle outer cowl and by said fan outer cowl converging toward one another until they meet;
a fan inner cowl delimiting said annular cold flow duct on said central hot flow generator side, passing through said cold flow outlet orifice and forming a projection out of said cold flow outlet orifice toward the rear of said turbojet engine; and
a cold flow nozzle throat which is formed, forward of said cold flow outlet orifice, between said fan inner cowl and said fan outer cowl and of which the annular cross section has a nominal area fixed by the thermodynamic cycle of said turbojet engine and smaller than the area of said cold flow outlet orifice, so that a convergent/divergent nozzle is formed at the rear part of said cold flow duct.

When an aircraft carrying such a turbojet engine is in flight, particularly in cruising flight, it is known that, because of the difference in pressures at said cold flow outlet orifice between said cold flow and the external aerodynamics airstream around said nacelle, an alternation of zones with supersonic heightened velocities and of zones with subsonic velocities appear in said cold flow to the rear of said nozzle throat, the transitions between the supersonic heightened zones and the subsonic zones being sudden, non-progressive, and with no intermediate velocity values and resulting in straight shocks. This means that said cold flow is the site of shock waves propagating to the rear of said turbojet engine and which not only generate a significant amount of noise (known as “shock cell noise”), but also degrade the performance of the turbojet engine and therefore that of the aircraft which carries it.

It is an object of the present invention to address these disadvantages taking into consideration the fact that, in general, aircraft, particularly civilian transport airplanes, are designed to repeatedly execute similar flight missions.

To this end, according to the invention, the method for improving the performance of a bypass turbojet engine, of the type recalled hereinabove and mounted on an aircraft that is to accomplish a determined flight mission comprising a phase of cruising flight, is notable in that:
the extreme values for the expansion ratio of said cold flow corresponding respectively to the start and the end of said cruising phase are determined;
from said extreme values, a reference value for said expansion ratio is chosen;
for this reference value of the expansion ratio, the theoretical value of the area of said cold flow outlet orifice is determined; and
said cold flow outlet orifice is positioned along said longitudinal axis in such a way that its area corresponds to said theoretical value.

Thus, by virtue of the present invention, the nozzle of said turbojet engine is at least approximately tailored to the conditions of the cruising flight of said mission, it then being possible for the pressure of the cold flow, at the outlet orifice therefor, to be close, if not equal, to the pressure of the aerodynamic airstream flowing around the nacelle. This causes the zones of heightened velocity and the shocks in said cold flow to disappear, thus improving turbojet engine performance and reducing the noise of these engines.

It will be noted that document US 2004/0031258 A1 mentions a turbojet engine in which, in order to avoid shockwaves at the nozzle exit, the value of the ratio between the inlet area and the outlet area of said nozzle is chosen accordingly. It may also be noted that document EP-A-1 619 375 describes a nozzle the geometry of which can be varied by axial sliding.

In the method according to the present invention, said values of the expansion ratio of said cold flow are determined by calculation, from parameters such as the type of aircraft, the aircraft mass, the desired performance, the required thrust, the flight altitude profile, etc.

It is therefore easy to determine the reference value for the expansion ratio as being at least approximately equal to the mean of said extreme values of the expansion ratio of said cold flow corresponding respectively to the start and to the end of said cruising phase.

Advantageously, said theoretical value of the area of said cold flow outlet orifice, corresponding to said reference value of the expansion ratio, is determined from an auxiliary theoretical value representative of the ratio between said theoretical area of said cold flow outlet orifice and said nominal cross-sectional area of said nozzle throat. Thus, said auxiliary theoretical value may be taken from the tables available to aerodynamicists and generally known as “isentropic compression or expansion tables—shock tables” (sometimes known in English as “expanded Mach number charts”).

Indeed it is known that there is, on the one hand, a first bijection between the expansion ratio (which is the ratio Pt/P between the total pressure Pt and the static pressure P—in this case ambient pressure) and the expanded Mach number M and, on the other hand, a second bijection between this expanded Mach number M and the ratio between the cross-sectional area of an isentropic stream tube (that is to say the theoretical area Ath of the outlet orifice) and the area of the cross section where the Mach number is equal to 1 (that is to say the area Ac of the nozzle throat).

Thus, for the reference value of the expansion ratio, said aforementioned tables or charts give first of all the expanded Mach number M, then the ratio Ath/Ac. Because the area Ac of the nozzle throat is nominal and known, it is easy from this to deduce the area Ath that the cold flow outlet orifice needs to have in order to tailor the cold flow nozzle to cruising flight.

When said fan inner cowl is at least approximately barrel-shaped, it is advantageous for said cold flow nozzle throat to be positioned to the rear of the maximum cross section of said fan inner cowl. Thus, said cold flow nozzle throat may be oriented in such a way that said cold flow is aligned with the mean cone of said nozzle.

Moreover, to make the present invention easier to implement, it is advantageous, at least in the vicinity of said annular cold flow outlet orifice, for the angle of convergence between said nacelle outer cowl and said fan outer cowl to be equal to a few degrees, for example of the order of 5 degrees.

The figures of the attached drawing will make it easy to understand how the invention may be embodied. In these figures, identical reference denote elements that are similar.

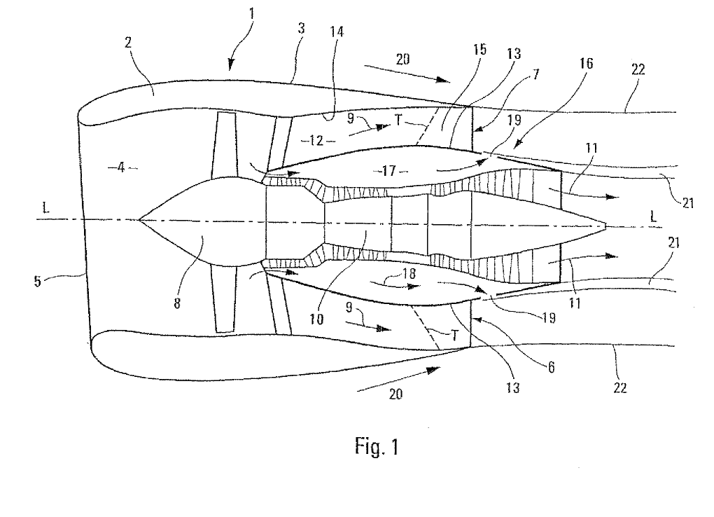

FIG. 1 depicts a turbojet engine according to the present invention, in schematic axial section.

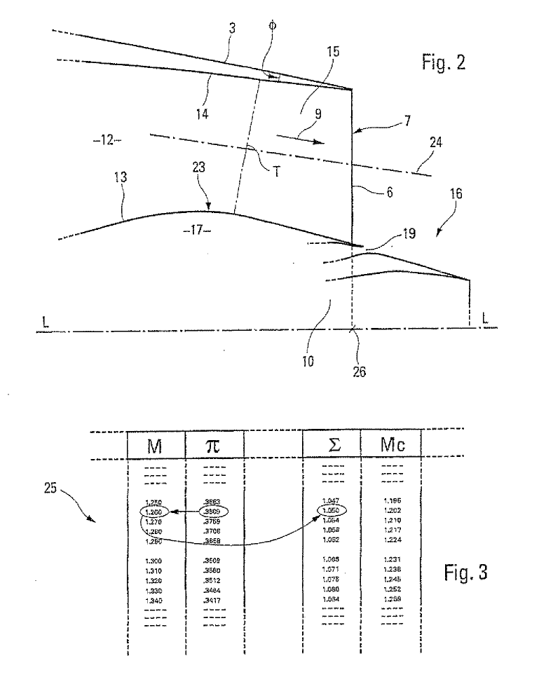

FIG. 2 shows the cold flow nozzle of the turbojet engine of FIG. 1, schematically and partially and on a larger scale.

FIG. 3 is a reproduction of an extract from the expanded Mach number charts available to aerodynamicists.

The bypass turbojet engine 1, of longitudinal axis L-L and shown in FIG. 1, comprises a nacelle 2 externally delimited by a nacelle outer cowl 3.

The nacelle 2 comprises, at the front, an air inlet 4 provided with a leading edge 5 and, at the rear, an air outlet orifice 6 delimited by a trailing edge 7.

Positioned inside said nacelle 2 are:
a fan 8 directed toward the air inlet 4 and able to generate the cold flow 9 of said turbojet engine 1;
a central generator 10 comprising, in the known way, low-pressure and high-pressure compressors, a combustion chamber, and low-pressure and high-pressure turbines, and which generates the hot flow 11 of said turbojet engine 1; and
an annular cold flow duct 12, formed around said central generator 10, between a fan inner cowl 13 positioned on the central generator 10 side and a fan outer cowl 14 positioned on the nacelle outer cowl 3 side.

The fan outer cowl 14 converges, toward the rear of the turbojet engine 1, in the direction of said nacelle outer cowl 3, to form therewith the edge 7 of said orifice 6, which therefore constitutes the outlet orifice for the cold flow. The angle Φ formed between said convergent cowls 3 and 14 in the vicinity of the trailing edge 7 has a value of a few degrees, for example 5 degrees (see FIG. 2).

The fan inner and outer cowls 13 and 14 between them form a nozzle 15 for said cold flow 9, the throat T of which nozzle is positioned forward of said outlet orifice 6 and indicated in chain line in FIG. 1. The nominal area Ac of the annular nozzle throat T is fixed by the thermodynamic cycle of the turbojet engine 1.

The area A of the annular outlet orifice 6 for the cold flow is greater than the nominal area Ac of the annular nozzle throat T, which means that the ratio A/Ac is greater than 1.

Thus, the nozzle 15 is of the convergent/divergent type and its convergence/divergence ratio (A-Ac) is of the order of a few percent, for example 0.5% to 1%.

Moreover, at the rear of the turbojet engine 1, said fan inner cowl 13 forms a projection 16 with respect to said fan outer cowl 14, said projection 16 being external to said cold flow outlet orifice 6.

The annular chamber 17 delimited between the fan inner cowl 13 and the central generator 10 can be put to good use to regulate the temperature of this central generator. To do so, fresh air from the fan 8 and symbolized by the arrows 18 is bled off at the front of said chamber 17 and discharged to the rear thereof through at least one vent opening 19 made in the fan inner cowl 13.

When the aircraft (not depicted) which carries the turbojet engine 1 is moving along, an external aerodynamic airstream 20 flows around the nacelle 2, while the cold flow 9 and hot flow 11 are ejected respectively by the orifice 6 and by the central generator 10: thus, the cold flow 9 surrounds the hot flow 11 and is itself surrounded by the aerodynamic airstream 20. A slip surface 21 is therefore formed between the cold flow 9 and the hot flow 11, and a slip surface 22 is formed between said external aerodynamic airstream 20 and said cold flow 9. In addition, the ventilation air 18 leaving via the opening 19 mixes first of all with the cold flow 9 and then with the hot flow 11, and becomes incorporated into the slip surface 21 between the two.

With the nozzle 15 shown in FIGS. 1 and 2 and according to the present invention, there is not, in the cold flow 9, any alternation of zones of heightened velocity and zones of subsonic velocities separated by straight shocks that generate noise and cause losses in performance for the turbojet engine 1, as explained hereinbelow.

First of all, because the fan inner cowl 13 is at least approximately barrel-shaped, it is advantageous for the nozzle throat T to be positioned near the maximum cross section 23 of said cowl 13, but to the rear of said maximum cross section, in order to benefit from a slight effect of curvature allowing said nozzle throat T to be oriented in such a way that said cold flow 9 is aligned with the mean cone 24 of said nozzle 15.

Moreover, by calculation, the values of the expansion ratio of the nozzle 15 at the start and at the end of the cruising phase of a flight mission that the aircraft carrying the turbojet engine 1 has chiefly to effect are determined. Next, the mean of these two values is determined in order to obtain a reference value VR for the expansion ratio, which is representative of the ratio Pt/P between the value Pt of the total pressure of the cold flow 9 and the value P of the static (ambient) pressure at the outlet of the annular orifice 6.

As partially depicted in FIG. 3, the expanded Mach number charts 25 available to the aerodynamicists collate the values for a plurality of aerodynamic parameters which correspond to one another. In FIG. 3, the extract of the chart 25 reproduced shows the Mach number M, the critical Mach number Mc, the parameter π representing the ratio of static pressure to total pressure and the parameter Σ representative of the ratio of the cross-sectional area of an isentropic stream tube to the area of the cross section where the Mach number is equal to 1.

Thus, for the value VR of the expansion ratio determined hereinabove (and which corresponds to the parameter 1/π), it is possible, by consulting the chart 25, to determine firstly the expanded Mach number M, then the value of the ratio Ath/Ac (which corresponds to the parameter Σ) between the theoretical area Ath of the outlet orifice 6 and the area Ac of the nozzle throat T.

For example, if the reference value VR is equal to 2.625—that is to say if π is equal to 0.3809—chart 25 shows that the expanded Mach number M is equal to 1.260 and that, for the latter value of M, the parameter Σ is equal to 1.050. Thus, in this particular example, the theoretical area Ath of the outlet orifice 6 of the cold flow ought to be equal to 1.050×Ac, that is to say that the convergence—divergence ratio for the cold flow nozzle 15 would be equal to 5%.

This then determines the theoretical value Ath that the area A of the cold flow outlet orifice 6 needs to have in order for said nozzle 15 to be tailored at least approximately to the cruising phase that the mission that the airplane carrying the turbojet engine 1 is to effect.

As a result, said outlet orifice 6 is positioned, along the axis L-L, at the location 26 at which, with due consideration to the shape of the fan inner cowl 13, its area A has the theoretical value Ath.

Of course, the opening 19 needs to be positioned in such a way that it lies to the rear of said outlet orifice 6.

1. A method for improving the performance of a bypass turbojet engine mounted on an aircraft that is to accomplish a determined flight mission comprising a phase of cruising flight, said turbojet engine comprising, around its longitudinal axis (L-L):
a nacelle (2) provided with a nacelle outer cowl (3) and containing a fan (8) generating the cold flow (9) and a central generator (10) generating the hot flow (11);
an annular cold flow duct (12) formed around said central hot flow generator (10);
a fan outer cowl (14) delimiting said annular cold flow duct (12) on the nacelle outer cowl (3) side;
an annular cold flow outlet orifice (6) of which the edge (7), which forms the trailing edge of said nacelle (2), is determined by said nacelle outer cowl (3) and by said fan outer cowl (14) converging toward one another until they meet;
a fan inner cowl (13) delimiting said annular cold flow duct (12) on said central hot flow generator (10) side, passing through said cold flow orifice (6) and forming a projection (16) out of said cold flow outlet orifice (6) toward the rear of said turbojet engine; and
a cold flow nozzle throat (T) which is formed, forward of said cold flow outlet orifice (6), between said fan inner cowl (13) and said fan outer cowl cowl (14) and of which the annular cross section has a nominal area (Ac) fixed by the thermodynamic cycle of said turbojet engine and smaller than the area (A) of said cold flow outlet orifice (6), so that a convergent/divergent nozzle (15) is formed at the rear part of said cold flow duct (12),
wherein:
the extreme values for the expansion ratio of said cold flow corresponding respectively to the start and to the end of said cruising phase are determined;
from said extreme values, a reference value (VR) for said expansion ratio is chosen;
for this reference value (VR) of the expansion ratio, the theoretical value (Ath) of the area of said cold flow outlet orifice (6) is determined; and
said cold flow outlet orifice (6) is positioned along said longitudinal axis (L-L) in such a way that its area corresponds to said theoretical value (Ath).

2. The method as claimed in claim 1,
wherein said extreme values of the expansion ratio of said cold flow are determined by calculation.

3. The method as claimed in claim 1,
wherein said reference value (VR) of the expansion ratio is at least approximately equal to the mean of said extreme values of the expansion ratio of said cold flow (9) corresponding respectively to the start and to the end of said cruising phase.

4. The method as claimed in claim 1,
wherein said theoretical value (Ath) of the area of said cold flow outlet orifice (6) is determined from an auxiliary theoretical value representative of the ratio between said theoretical area of said cold flow outlet orifice and said nominal cross-sectional area of said nozzle throat.

5. The method as claimed in claim 4,
wherein said auxiliary theoretical value is taken from “expanded Mach number charts”.

6. A bypass turbojet engine mounted on an aircraft that is to accomplish a determined flight mission comprising a phase of cruising flight, said turbojet engine comprising, around its longitudinal axis (L-L):
a nacelle (2) provided with a nacelle outer cowl (3) and containing a fan (8) generating the cold flow (9) and a central generator (10) generating the hot flow (11);
an annular cold flow duct (12) formed around said central hot flow generator (10);
a fan outer cowl (14) delimiting said annular cold flow duct (12) on the nacelle outer cowl (3) side;
an annular cold flow outlet orifice (6) of which the edge (7), which forms the trailing edge of said nacelle (2), is determined by said nacelle outer cowl (3) and by said fan outer cowl (14) converging toward one another until they meet;
a fan inner cowl (13) delimiting said annular cold flow duct (12) on said central hot flow generator (10) side, passing through said cold flow outlet orifice (6) and forming a projection out of said cold flow outlet orifice (6) toward the rear of said turbojet engine; and
a cold flow nozzle throat (T) which is formed, forward of said cold flow outlet orifice (6), between said fan inner cowl (13) and said fan outer cowl (14) and of which the annular cross section has a nominal area (Ac) fixed by the thermodynamic cycle of said turbojet engine and smaller than the area (A) of said cold flow outlet orifice (6), so that a convergent/divergent nozzle (15) is formed at the rear part of said cold flow duct (12),
said turbojet engine implementing a method specified in claim 1 and said fan inner cowl (13) being at least approximately barrel-shaped, wherein said cold flow nozzle throat (T) is positioned to the rear of the maximum cross section (23) of said fan inner cowl (13).

7. The turbojet engine as claimed in claim 6, wherein said cold flow nozzle throat (T) is oriented in such a way that said cold flow (9) is aligned with the mean cone (24) of said nozzle (15).

8. The turbojet engine as claimed in claim 6,
wherein, at least in the vicinity of said annular cold flow outlet orifice (6), the angle of convergence between said nacelle outer cowl (3) and said fan outer cowl (14) is equal to a few degrees.
